(19) United States
(12) Patent Application Publication
(10) Pub. No.: US 2026/0196537 A1
(43) Pub. Date: Jul. 9, 2026

(54) FUEL CELL MODULE

(71) Applicant: KABUSHIKI KAISHA TOYOTA JIDOSHOKKI, Kariya-shi (JP)

(72) Inventors: Ryo KATO, Kariya-shi (JP); Atsushi SAIKI, Kariya-shi (JP)

(73) Assignee: KABUSHIKI KAISHA TOYOTA JIDOSHOKKI, Kariya-shi (JP)

(21) Appl. No.: 19/434,691

(22) Filed: Dec. 29, 2025

(30) Foreign Application Priority Data
Jan. 7, 2025 (JP) 2025-002365

(51) Int. Cl. H01M 8/04119

(52) U.S. Cl. CPC H01M 8/04164; H01M 2250/20

(57) ABSTRACT

A fuel cell module includes a fuel cell and a gas-liquid separator. The gas-liquid separator includes: a diluter having a first space into which oxidizing agent gas and first product water flow; a second space into which hydrogen gas and second product water flow; and an outlet through which the hydrogen gas is discharged through the first space, and a water tank. The gas-liquid separator includes at least one first communication port through which these product water flow from the first space into the water tank, at least one second communication port through which these second product water flow from the second space into the water tank, a first plate portion extending from the first communication port toward a bottom of the water tank, and a second plate portion extending from the second communication port toward the bottom of the water tank.

### CROSS-REFERENCE OF THE RELATED APPLICATION

This application claims priority to Japanese Patent Application No. 2025-002365 filed on January 7, 2025, the entire disclosure of which is incorporated herein by reference.

### BACKGROUND ART

The present disclosure relates to a fuel cell module.

Some fuel cell modules include a diluter and a gas-liquid separator. As for the diluter, oxidizing agent gas, hydrogen gas, and product water are discharged from a fuel cell and flow into the diluter, and then, the hydrogen gas and the oxidizing agent gas are discharged from the diluter to the outside of the diluter through an outlet. The gas-liquid separator has a water tank for storing the product water flowing from the diluter through a communication port. Japanese Patent Application Publication No. 2020-135996 (first Publication) has been known as a prior art of such fuel cell modules.

In a case where the fuel cell module is mounted on a moving body, during acceleration or turning of the moving body, an inertial force acts on the product water in the water tank to cause the water surface of the product water to tilt or undulate. This may cause a water level of the product water in the water tank to be higher. When the water level of the product water in the water tank becomes higher, the product water in the water tank may flow back to the diluter through the communication port and the product water that has flowed back to the diluter may leak to the outside of the diluter through the outlet.

Here, other fuel cell modules include a plate portion extending from a communication port toward the bottom of a water tank, thereby suppressing that the water surface of product water in the water tank rises and undulates during acceleration or turning of a moving body. In these other fuel cell modules, it is suppressed that the product water flows back to a diluter from the water tank during acceleration or turning of the moving body. This suppresses an increase of the product water in the diluter, thereby preventing the product water in the diluter from leaking to the outside of the diluter through an outlet. Japanese Patent Application Publication No. 2023-106000 (second Publication) has been known as a prior art of such fuel cell modules.

However, regarding the above-mentioned fuel cell modules in the first and second Publications, in a case where a relatively large amount of the product water is discharged from the fuel cell, the product water is likely to remain in the diluter. As a result, the product water in the diluter may leak to the outside of the diluter through the outlet during acceleration or turning of the moving body.

An object according to one aspect of the present disclosure is to enhance a water leakage prevention performance in a fuel cell module.

### SUMMARY

In accordance with an aspect of the present disclosure, there is provided a fuel cell module that includes a fuel cell, and a gas-liquid separator including a diluter having: a first space into which oxidizing agent gas and first product water that are discharged from the fuel cell flow; a second space into which hydrogen gas and second product water that are discharged from the fuel cell flow; and an outlet through which the hydrogen gas flowing into the second space is discharged, together with the oxidizing agent gas, to an outside of the diluter through the first space, a water tank in which the first product water and the second product water are stored, at least one first communication port through which the first product water and the second product water flow from the first space into the water tank, at least one second communication port through which the first product water and the second product water flow from the second space into the water tank, a first plate portion surrounding the first communication port and extending from the first communication port toward a bottom of the water tank, and a second plate portion surrounding the second communication port and extending from the second communication port toward the bottom of the water tank.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a diagram illustrating an example of a fuel cell module according to an embodiment;

FIG. 2 is a perspective view of a gas-liquid separator;

FIG. 3 is a view schematically illustrating an aspect of oxidizing agent gas, first product water, hydrogen gas, and second product water flowing in the gas-liquid separator;

FIG. 4 is a view schematically illustrating an aspect of the oxidizing agent gas and the hydrogen gas flowing in a diluter;

FIGS. 5A to 5E are views schematically each illustrating an aspect of a water surface in a first plate portion and a water surface in a second plate portion;

FIG. 6 is a view illustrating first and second plate portions according to a first modification; and

FIG. 7 is a view illustrating a first plate portion according to a second modification.

### DETAILED DESCRIPTION OF THE EMBODIMENT

In a fuel cell module of an embodiment, when a fuel cell stack generates power, oxidizing agent gas (cathode off-gas) including unreacted oxygen, hydrogen gas (anode off-gas) including unreacted hydrogen, and product water are discharged from the fuel cell stack. For example, in a case where the fuel cell module is mounted on an industrial vehicle, such as a forklift that is also used indoors, a water storage structure for preventing the product water from leaking to the outside of the industrial vehicle may be required, in addition to diluting the hydrogen to a concentration equal to or below a reference concentration and discharging the diluted hydrogen. This is because, unlike a passenger car that is mainly used outdoors, the product water leaking to the outside of the industrial vehicle may soak an indoor environment, which causes inconvenience for a user.

Regarding the prevention of the leakage of the product water during the power generation, for example, it is necessary to meet the following requirements: the product water does not leak due to the undulation of the product water caused by acceleration, deceleration, turning, or the like during traveling of the industrial vehicle; the product water that is discharged together with the oxidizing agent gas and the hydrogen gas during the power generation is separated from these gases and is stored; all the product water that is discharged until the hydrogen in the fuel tank is fully consumed is stored; the fuel cell module contributes to reduction of a required installation space (as the capacity of the water tank decreases, a water leakage prevention performance is reduced); and the fuel cell module is manufactured at low cost (the fuel cell module has a simple structure).

Regarding the dilution of the hydrogen, for example, it is necessary to meet the following requirements: the hydrogen with a concentration of 70% to 100% is diluted to a concentration of about a few percent (4% to 8%); the hydrogen gas is diluted in correspondence with intermittent discharge of the hydrogen gas (remaining hydrogen gas is diluted by next discharge, which occurs, for example, several tens of seconds after present discharge), the fuel cell module contributes to reduction of a required installation space (as the capacity of the diluter decreases, a dilution performance is reduced due to reduction of a buffer region for the hydrogen gas); and the fuel cell module is manufactured at low cost (the fuel cell module has a simple structure).

In the fuel cell module of the embodiment, a structure of a gas-liquid separator is improved to particularly meet the requirement for enhancing the water leakage prevention performance, among the various requirements mentioned above.

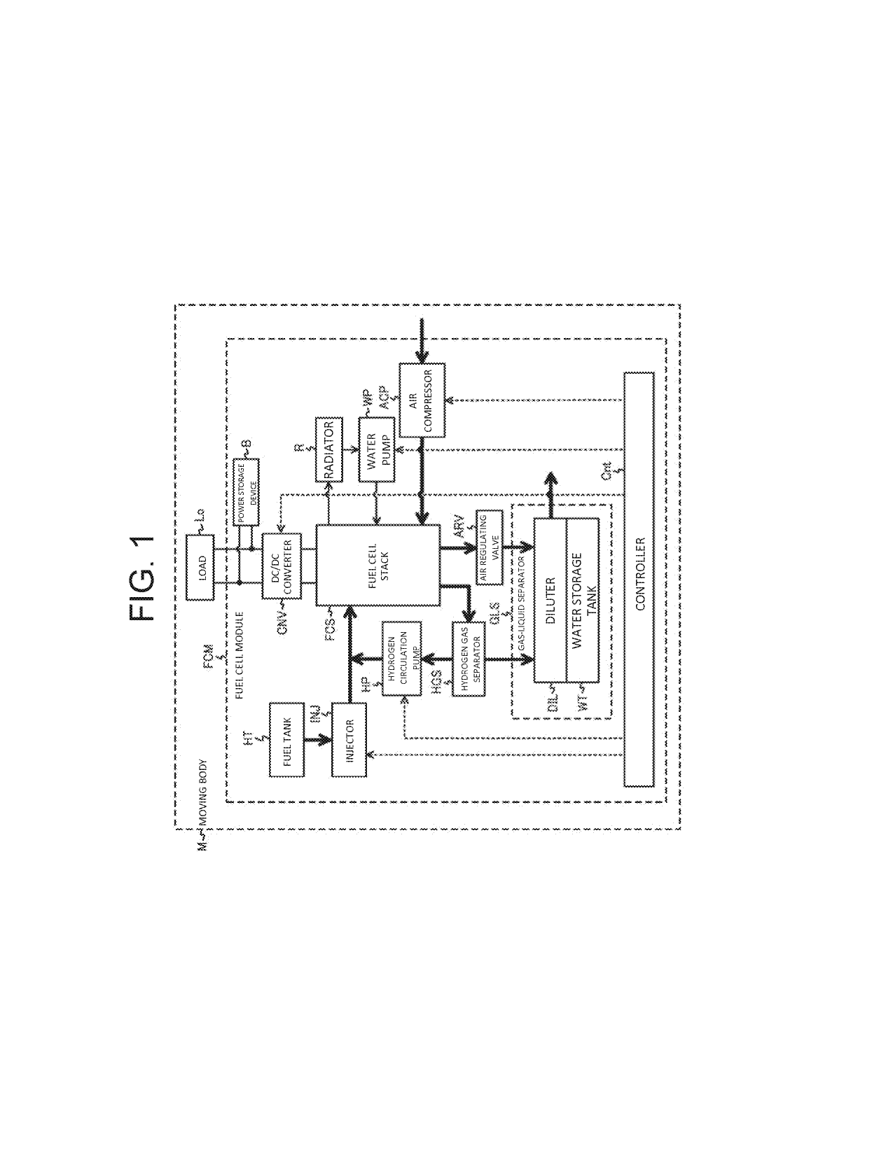

FIG. 1 is a diagram illustrating an example of the fuel cell module according to the embodiment.

A fuel cell module FCM illustrated in FIG. 1 is, for example, mounted on a vehicle such as a forklift; a towing tractor; or an automatic guided vehicle (AGV), or on an aerial vehicle such as a drone. In the following description, the vehicle, the aerial vehicle, or the like on which the fuel cell module FCM is mounted is defined as a moving body M. The fuel cell module FCM supplies power to a load Lo mounted on the moving body M. The load Lo is, for example, an inverter circuit that drives a motor for traveling or flying, electrical equipment, or the like. Note that the fuel cell module FCM of the embodiment may refer to the fuel cell module FCM before being mounted on the moving body M or after being mounted on the moving body M.

The fuel cell module FCM also includes a fuel cell stack FCS (fuel cell) as a primary apparatus and a plurality of types of auxiliary apparatuses for causing the fuel cell stack FCS to generate power.

In other words, the fuel cell module FCM includes a DC/DC converter CNV, a power storage device B, and the like, as electrical system auxiliary apparatuses.

The fuel cell module FCM includes a radiator R, a water pump WP, and the like, as cooling system auxiliary apparatuses.

The fuel cell module FCM includes a fuel tank HT, an injector INJ, a hydrogen gas separator HGS, a hydrogen circulation pump HP, a gas-liquid separator GLS, and the like, as hydrogen gas system auxiliary apparatuses.

The fuel cell module FCM includes an air compressor ACP, an air regulating valve ARV, and the like, as oxidizing agent gas system auxiliary apparatuses.

The fuel cell module FCM further includes a controller Cnt, and the like.

The fuel cell stack FCS includes a plurality of fuel cells connected in series to each other and generates electricity by an electrochemical reaction between hydrogen in the hydrogen gas as anode gas and oxidizing agent gas (for example, air) as cathode gas. Each fuel cell is, for example, a polymer electrolyte fuel cell (PEFC).

The DC/DC converter CNV changes a voltage output from the fuel cell stack FCS to a predetermined voltage. The power output from the DC/DC converter CNV is supplied to each of the auxiliary apparatus and the load Lo.

The power storage device B is formed of a lithium-ion battery or a lithium-ion capacitor, and the like, and is connected between the DC/DC converter CNV and the load Lo. When supply power corresponding to a difference between the power output from the DC/DC converter CNV and a sum of powers supplied to the auxiliary apparatuses is greater than power required by an external device (for example, a controller that controls operation of the load Lo and which is not illustrated) connected to the fuel cell module FCM, power equal to the required power, of the supply power, is supplied to the load Lo and the surplus power is supplied to the power storage device B. When the power is supplied from the DC/DC converter CNV to the power storage device B, the power storage device B is charged and a state of charge (a ratio [%] of a remaining capacity to a full charge capacity) in the power storage device B increases. Furthermore, when regenerative power supplied from the load Lo is supplied to the power storage device B through the fuel cell module FCM, the power storage device B is charged and the state of charge in the power storage device B increases. On the other hand, when the supply power is less than the required power, the supply power is supplied to the load Lo, and power corresponding to the shortfall in power relative to the required power is supplied from the power storage device B to the load Lo. When the power is supplied from the power storage device B to the load Lo, the power storage device B is discharged and the state of charge in the power storage device B decreases.

Heat is exchanged between the coolant discharged from the fuel cell module FCM and surrounding air at the radiator R.

Water pump WP supplies the coolant, which has been cooled at the radiator R, to the fuel cell stack FCS.

The fuel tank HT is a storage container for the hydrogen gas. The hydrogen gas stored in the fuel tank HT is supplied to the fuel cell stack FCS through the injector INJ.

The injector INJ adjusts a flow rate of hydrogen gas that is supplied to the fuel cell stack FCS.

The hydrogen gas separator HGS separates the hydrogen gas discharged from the fuel cell stack FCS and including the unreacted hydrogen from the first product water produced in the fuel cell stack FCS. The hydrogen gas separator HGS sends some of the separated hydrogen gas and the first product water to the gas-liquid separator GLS, and sends the rest separated hydrogen gas to the hydrogen circulation pump HP.

The hydrogen circulation pump HP supplies the hydrogen gas sent from the hydrogen gas separator HGS back to the fuel cell stack FCS.

The air compressor ACP compresses the oxidizing agent gas supplied from the outside of the fuel cell module FCM and supplies the compressed gas to the fuel cell stack FCS.

The air regulating valve ARV adjusts pressure and a flow rate of the oxidizing agent gas that is supplied to the fuel cell stack FCS.

The controller Cnt is formed of, for example, a microcomputer, and controls operation of each auxiliary apparatus in order to control the power generation of the fuel cell stack FCS. For example, the controller Cnt changes target generation power in correspondence with the state of charge in the power storage device B and controls the operation of each auxiliary apparatus so that the power generated by the fuel cell stack FCS follows the target generation power using proportional-integral (PI) control, or the like.

The gas-liquid separator GLS has a diluter DIL and a water tank WT. The shape of the housing that forms the diluter DIL and the water tank WT has design flexibility and may be modified in various ways. For example, the housing has a substantially rectangular parallelepiped shape. The material of the housing that is used to form the diluter DIL and the water tank WT has design flexibility and may be modified in various ways. For example, the housing is made of stainless steel obtained by adding chromium, nickel, molybdenum, or the like to iron, carbon fiber reinforced plastics (CFRP), or plastic, such as polypropylene. The position of the gas-liquid separator GLS in the fuel cell module FCM is not particularly limited, but it is desirable to position the gas-liquid separator GLS below the fuel cell stack FCS in order to reduce the size of the fuel cell module FCM.

The unreacted hydrogen gas discharged from the fuel cell stack FCS and the second product water flow into the diluter DIL through the hydrogen gas separator HGS, and the unreacted oxidizing agent gas discharged from the fuel cell stack FCS and the first product water flow into the diluter DIL through the air regulating valve ARV. The diluter DIL dilutes the hydrogen gas with the oxidizing agent gas (mixes the hydrogen gas with the oxidizing agent gas) and discharges the diluted gas to the outside of the diluter DIL. Furthermore, the diluter DIL sends the first product water and the second product water to the water tank WT. The hydrogen gas and the oxidizing agent gas after being diluted (mixed) are hereinafter referred to as the “diluted gas”. In a case where there is no need to distinguish between the first product water and the second product water, such water is hereinafter simply referred to as “product water”.

The product water sent from the diluter DIL is stored in the water tank WT. The water tank WT may be configured so that the product water stored in the water tank WT is drained through a drain port formed at the bottom of the water tank WT, which is not illustrated, during maintenance or the like of the fuel cell module FCM.

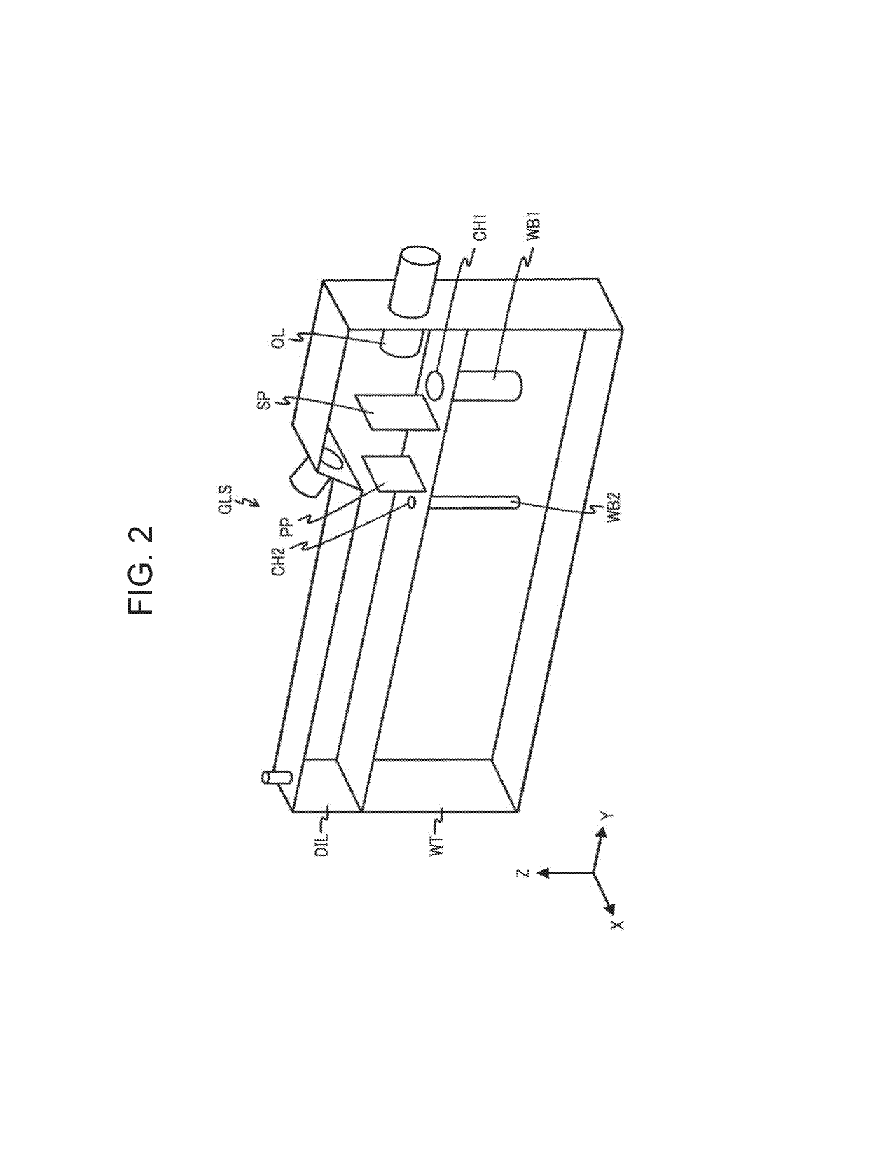

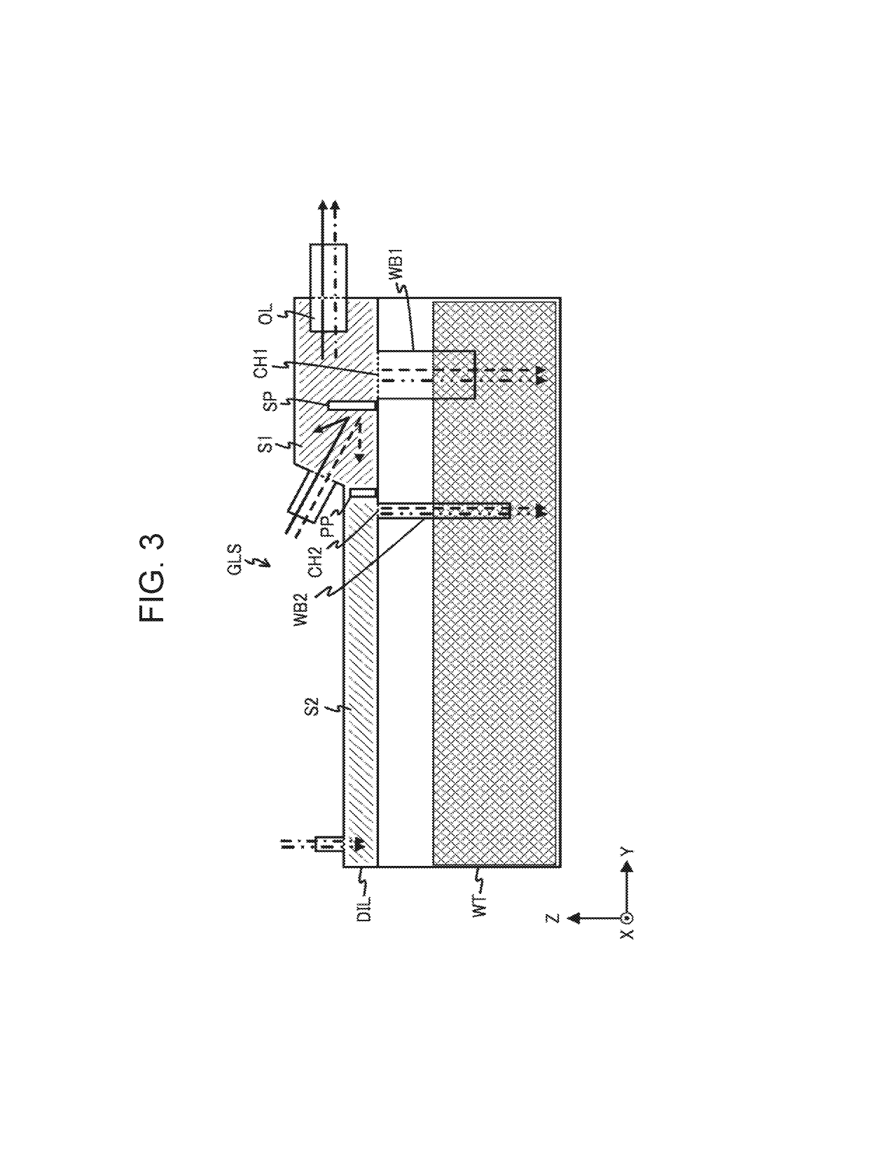

FIG. 2 is a perspective view of the gas-liquid separator GLS. An X-axis, a Y-axis, and a Z-axis in FIG. 2 and the subsequent FIGS. 3 to 7 are illustrated in order to define a direction and a posture of the gas-liquid separator GLS. The X-axis, Y-axis, and Z-axis are perpendicular to one another and form a right-handed coordinate system. Aspect ratios of the gas-liquid separator GLS and the diluter DIL and a size relationship between their components are just schematically illustrated in FIGS. 2 to 7, and do not necessarily match aspect ratios of the actually manufactured gas-liquid separator GLS and diluter DIL and the size relationship between their components. For the sake of description, the size relationship between the components may be expressed in an exaggerated manner. The side wall of the gas-liquid separator GLS (diluter DIL and water tank WT) located on a positive side in an X-axis direction in FIG. 2 is omitted in order to illustrate an internal configuration of the gas-liquid separator GLS. Also in FIGS. 3 to 7, when the internal configuration of the gas-liquid separator GLS is illustrated, some surfaces of the gas-liquid separator GLS are omitted. In an example illustrated in FIG. 2, the diluter DIL is formed integrally with the water tank WT, and the bottom of the diluter DIL and the ceiling of the water tank WT are formed of a common member.

The gas-liquid separator GLS illustrated in FIG. 2 includes a partition plate PP, an outlet OL, a disturbance plate SP, a first communication port CH1, a second communication port CH2, a first plate portion WB1, and a second plate portion WB2.

The partition plate PP is formed near the center of the diluter DIL so as to extend from the bottom of the diluter DIL (the bottom wall of the diluter DIL located on a negative side in a Z-axis direction) to the ceiling of the diluter DIL (the upper wall of the diluter DIL located on a positive side in the Z-axis direction). In the example illustrated in FIG. 2, the partition plate PP is formed in a substantially rectangular plate shape and is spaced apart from each of the upper wall of the diluter DIL located on the positive side in the Z-axis direction, the side wall of the diluter DIL located on the positive side in the X-axis direction, and the side wall of the diluter DIL located on a negative side in the X-axis direction. The shape of the partition plate PP is not particularly limited as long as the diluted gas can flow from a first space S1 to a second space S2, and vice versa, which will be described later.

The outlet OL is formed so as to extend from the inside of the diluter DIL to the outside of the diluter DIL through the side wall of the diluter DIL located on a positive side in a Y-axis direction. In the example illustrated in FIG. 2, the outlet OL is formed in a substantially cylindrical shape, and one end of the outlet OL into which the diluted gas flows is located inside the diluter DIL, and the other end of the outlet OL from which the diluted gas flows is located outside the diluter DIL.

The disturbance plate SP is formed between the partition plate PP and the outlet OL so as to extend from the bottom to the ceiling of the diluter DIL. That is, the disturbance plate SP is provided in the first space, which will be described later. In the example illustrated in FIG. 2, the disturbance plate SP is formed in a substantially rectangular plate shape and is spaced apart from each of the upper wall of the diluter DIL located on the positive side in the Z-axis direction, the side wall of the diluter DIL located on the positive side in the X-axis direction, and the side wall of the diluter DIL located on the negative side in the X-axis direction. The shape of the disturbance plate SP is not particularly limited as long as the disturbance plate SP is capable of disturbing the flow of the oxidizing agent gas flowing into the first space S1.

The first communication port CH1 is a through hole and is provided at the bottom of the diluter DIL (or the ceiling of the water tank WT). In the example illustrated in FIG. 2, the first communication port CH1 is located near the disturbance plate SP between the disturbance plate SP and the outlet OL, that is, near the disturbance plate SP interposed between the first communication port CH1 and a side from which the oxidizing agent gas flows into the first space. However, the position of the first communication port CH1 is not particularly limited as long as the first communication port CH1 is located at the bottom of the diluter DIL in the first space S1 described below. In the example illustrated in FIG. 2, the cross-sectional shape of the first communication port CH1 is a substantially circular shape. However, the cross-sectional shape of the first communication port CH1 may be a substantially rectangular shape and is not particularly limited. Furthermore, the size of the first communication port CH1 is not particularly limited. However, as the size of the first communication port CH1 increases, the product water more easily flows from the diluter DIL to the water tank WT through the first communication port CH1, but more easily leaks from the water tank WT to the diluter DIL through the first communication port CH1. Accordingly, it is desirable to set the first communication port CH1 to an optimal size, taking both the advantage and the disadvantage into consideration.

The second communication port CH2 is a through hole different from the first communication port CH1 and is formed at the bottom of the diluter DIL (or the ceiling of the water tank WT). In the example illustrated in FIG. 2, the second communication port CH2 is located near the partition plate PP between the partition plate PP and the side wall of the diluter DIL located on the negative side in the Y-axis direction. However, the position of the second communication port CH2 is not particularly limited as long as the second communication port CH2 is located at the bottom of the diluter DIL in the second space S2 described below. In the example illustrated in FIG. 2, the cross-sectional shape of the second communication port CH2 is a substantially circular shape. However, the cross-sectional shape of the second communication port CH2 may be a substantially rectangular shape and is not particularly limited. Furthermore, the size of the second communication port CH2 is not particularly limited. However, as the size of the second communication port CH2 increases, the product water more easily flows from the diluter DIL to the water tank WT through the second communication port CH2, but more easily leaks from the water tank WT to the diluter DIL through the second communication port CH2. Accordingly, it is desirable to set the second communication port CH2 to an optimal size, taking both the advantage and the disadvantage into consideration.

When the diluter DIL is provided separately from the water tank WT, the first communication port CH1 has two ports facing each other. One port of the first communication port CH1 is formed at the bottom of the diluter DIL and the other port of the first communication port CH1 is formed at the ceiling of the water tank WT. Similarly, the second communication port CH2 has two ports facing each other. One port of the second communication port CH2 is formed at the bottom of the diluter DIL and the other port of the second communication port CH2 is formed at the ceiling of the water tank WT.

The first plate portion WB1 is a baffle plate for suppressing undulation of the product water in the water tank WT and is formed so as to surround the first communication port CH1 and extend from the first communication port CH1 toward the bottom of the water tank WT (toward the negative side in the Z-axis direction). In the example illustrated in FIG. 2, the first plate portion WB1 is formed in a substantially cylindrical shape, and one end of the first plate portion WB1 into which the product water flows is connected to the first communication port CH1 and the other end of the first plate portion WB1 from which the product water flows is located inside the water tank WT. The other end of the first plate portion WB1 is spaced apart from the bottom of the water tank WT.

Similarly to the first plate portion WB1, the second plate portion WB2 is a baffle plate for suppressing undulation of the product water in the water tank WT, and is formed so as to surround the second communication port CH2 and extend from the second communication port CH2 toward the bottom of the water tank WT. In the example illustrated in FIG. 2, the second plate portion WB2 is formed in a substantially cylindrical shape, and one end of the second plate portion WB2 into which the product water flows is connected to the second communication port CH2 and the other end of the second plate portion WB2 from which the product water flows is located inside the water tank WT. The other end of the second plate portion WB2 is spaced apart from the bottom of the water tank WT.

The first plate portion WB1 and the second plate portion WB2 have a function to adjust a water level of the product water stored in the water tank WT.

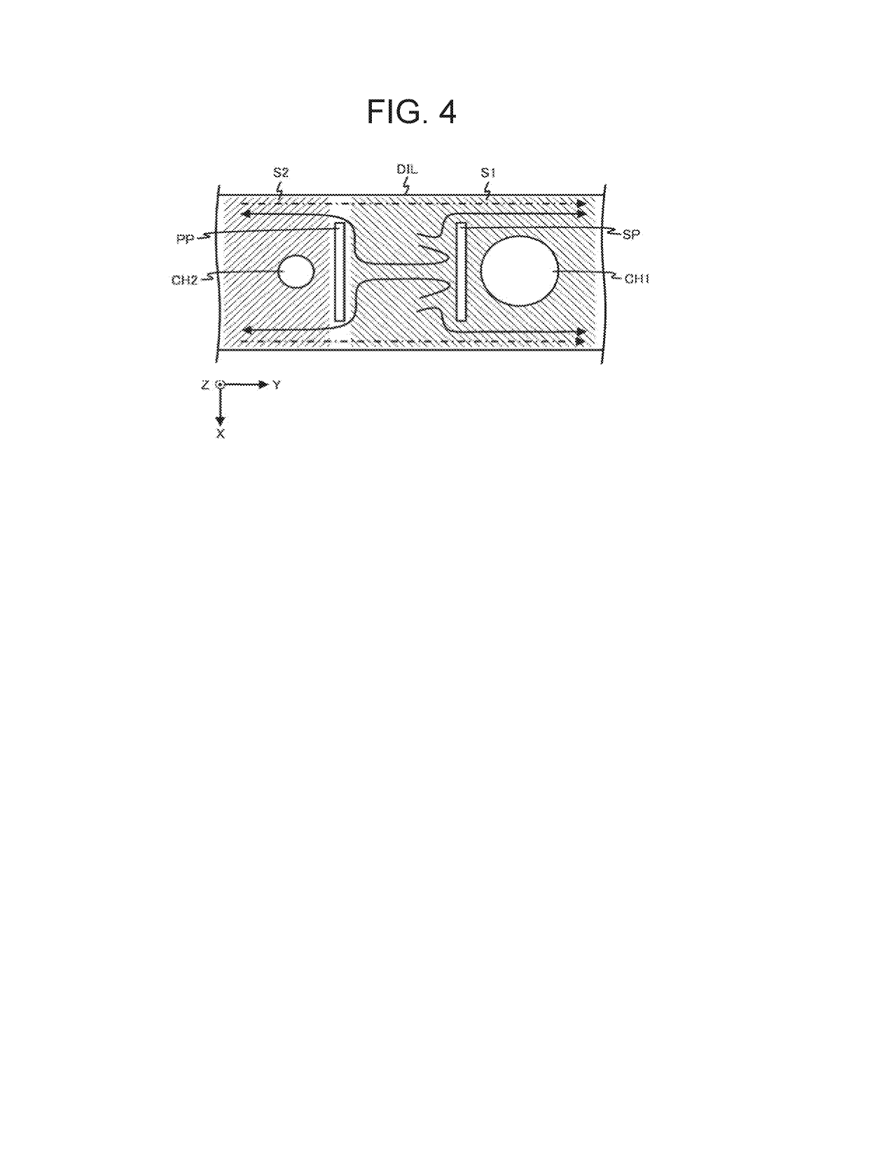

FIG. 3 is a view schematically illustrating an aspect of the oxidizing agent gas, the first product water, the hydrogen gas, and the second product water flowing in the gas-liquid separator GLS. FIG. 4 is a view schematically illustrating an aspect of the oxidizing agent gas and the hydrogen gas flowing in the diluter DIL. In FIGS. 3 and 4, the flow of the oxidizing agent gas is indicated by solid arrows, the flow of the first product water is indicated by broken arrows, the flow of the hydrogen gas is indicated by long dashed short dashed arrows, and the flow of the second product water is indicated by long dashed double-short dashed arrows. The entire space in the diluter DIL is divided into the first space S1 (indicated by a hatched area with lines extending toward the upper-right relative to each sheet in FIGS. 3 and 4) and the second space S2 (indicated by a hatched area with lines extending toward the lower-right relative to each sheet in FIGS. 3 and 4) by the partition plate PP. That is, the hydrogen gas remains in the second space S2 due to the partition plate PP provided between the first space S1 and the second space S2. The product water stored in the water tank WT is indicated by a cross-hatched area illustrated in FIG. 3.

The oxidizing agent gas that is discharged from the fuel cell stack FCS and flows into the first space S1 impinges on the disturbance plate SP to be disturbed. Then, some of the disturbed oxidizing agent gas impinges on the partition plate PP and remains in the first space S1, and the rest of the disturbed oxidizing agent gas flows to the second space S2 through a space between the partition plate PP and each wall of the diluter DIL or a space between the partition plate PP and the ceiling of the diluter DIL.

The hydrogen gas that is discharged from the fuel cell stack FCS and flows into the second space S2 is diluted with the oxidizing agent gas in the second space S2. When the diluted gas impinges on the partition plate PP, some of the diluted gas remains in the second space S2, and the rest of the diluted gas flows to the first space S1 through the space between the partition plate PP and each wall of the diluter DIL and the space between the partition plate PP and the ceiling of the diluter DIL.

The diluted gas flowing from the second space S2 to the first space S1 is further diluted with the oxidizing agent gas remaining in the first space S1, and is then discharged to the outside of the diluter DIL through the outlet OL. Thus, the hydrogen gas discharged from the fuel cell stack FCS is diluted in the second space S2, and is then further diluted in the first space S1, so that a dilution performance of the diluter DIL may be improved.

The first product water that is discharged from the fuel cell stack FCS and flows into the first space S1 impinges on the disturbance plate SP to be disturbed. Some of the disturbed first product water flows to the second space S2 through the space between the partition plate PP and each wall of the diluter DIL, and the rest of the disturbed first product water impinges on the partition plate PP and remains in the first space S1.

In the second product water that is discharged from the fuel cell stack FCS and flows into the second space S2, some of the second product water flows into the water tank WT through the second communication port CH2 together with the first product water. The rest of the second product water flows to the first space S1 through the space between the partition plate PP and each wall of the diluter DIL and then flows to the water tank WT through the first communication port CH1 together with the first product water.

Thus, since the fuel cell module FCM of the embodiment includes at least the first communication port CH1 and at least the second communication port CH2, as compared with a fuel cell module including one communication port, the product water flowing from the diluter DIL to the water tank WT may be increased. This reduces the product water remaining in the diluter DIL, so that the product water is prevented from leaking to the outside of the diluter DIL through the outlet OL.

As illustrated in FIG. 4, in the embodiment, the first communication port CH1 is located near the disturbance plate SP, that is, the first communication port CH1 is located at a position where the oxidizing agent gas remains (a position where a wind speed, that is, a flow rate of the oxidizing agent gas becomes relatively small). This configuration suppresses that the product water near the first communication port CH1 is blown away or swirled upward by the oxidizing agent gas flowing into the first space S1, and makes it easier for the product water in the first space S1 to flow into the water tank WT through the first communication port CH1, so that the amount of the product water remaining in the diluter DIL is reduced. As a result, the product water in the diluter DIL is further prevented from leaking to the outside of the diluter DIL through the outlet OL.

As illustrated in FIG. 4, since the second communication port CH2 is located near the partition plate PP, the second communication port CH2 is located at a position where the oxidizing agent gas remains (a position where a wind speed, that is, a flow rate of the oxidizing agent gas becomes relatively small). This configuration suppresses that the product water near the second communication port CH2 is blown away or swirled upward by the oxidizing agent gas flowing into the second space S2, and makes it easier for the product water in the second space S2 to flow into the water tank WT through the second communication port CH2, so that the amount of the product water remaining in the diluter DIL is reduced. As a result, the product water in the diluter DIL is further prevented from leaking to the outside of the diluter DIL through the outlet OL.

A plurality of the first communication ports CH1 may be formed in the first space S1. Thus, when the plurality of the first communication ports CH1 are formed, a plurality of the first plate portions WB1 may be each connected to a corresponding one of the first communication ports CH1, or only one first plate portion WB1 may be connected to the first communication ports CH1.

A plurality of the second communication ports CH2 may be formed in the second space S2. Thus, when the plurality of the second communication ports CH2 are formed, similarly to a case where the plurality of the first communication ports CH1 are formed, a plurality of the second plate portions WB2 may be each connected to a corresponding one of the second communication ports CH2, or only one second plate portion WB2 may be connected to the second communication ports CH2.

The inner diameters of the first communication port CH1 and the second communication port CH2 are not particularly limited.

As the numbers of the first communication ports CH1 and the second communication ports CH2 increase or as the inner diameters of the first communication port CH1 and the second communication port CH2 increase, the product water flowing from the diluter DIL into the water tank WT increases. However, the product water easily flows back to the diluter DIL from the water tank WT depending on a capacity of the water tank WT. Accordingly, it is desirable that the numbers of the first communication ports CH1 and the second communication ports CH2 and the inner diameters of the first communication port CH1 and the second communication port CH2 are set to appropriate values, taking into account parameters such as the capacity of the water tank WT.

Here, in a state where the moving body M is moving at positive acceleration or negative acceleration, or a state where the moving body M is turning right or turning left (hereinafter, defined as during acceleration or turning of the moving body M), it is assumed that an inertial force acting on the product water in the water tank WT in addition to atmospheric pressure causes the water surface of the product water in the water tank WT to tilt. Note that a state where the moving body M stops or a state where the moving body M is moving at a constant speed is defined as “during non-acceleration and non-turning of the moving body M”. During non-acceleration and non-turning of the moving body M, when the water surface of the product water in the water tank WT becomes higher than the other ends of the first plate portion WB1 and the second plate portion WB2 located on the negative side in the Z-axis direction, air in a space (hereinafter, referred to as the space A) defined by the ceiling and the walls of the water tank WT, the outer side surface of the first plate portion WB1, the outer side surface of the second plate portion WB2, and the water surface of the product water leaks to the diluter DIL through an air hole formed in the ceiling or the like, which is not illustrated, of the water tank WT. This makes the water surface of the product water in the first plate portion WB1, the water surface of the product water in the second plate portion WB2, and the water surface of the product water in the space A equal in height to each other.

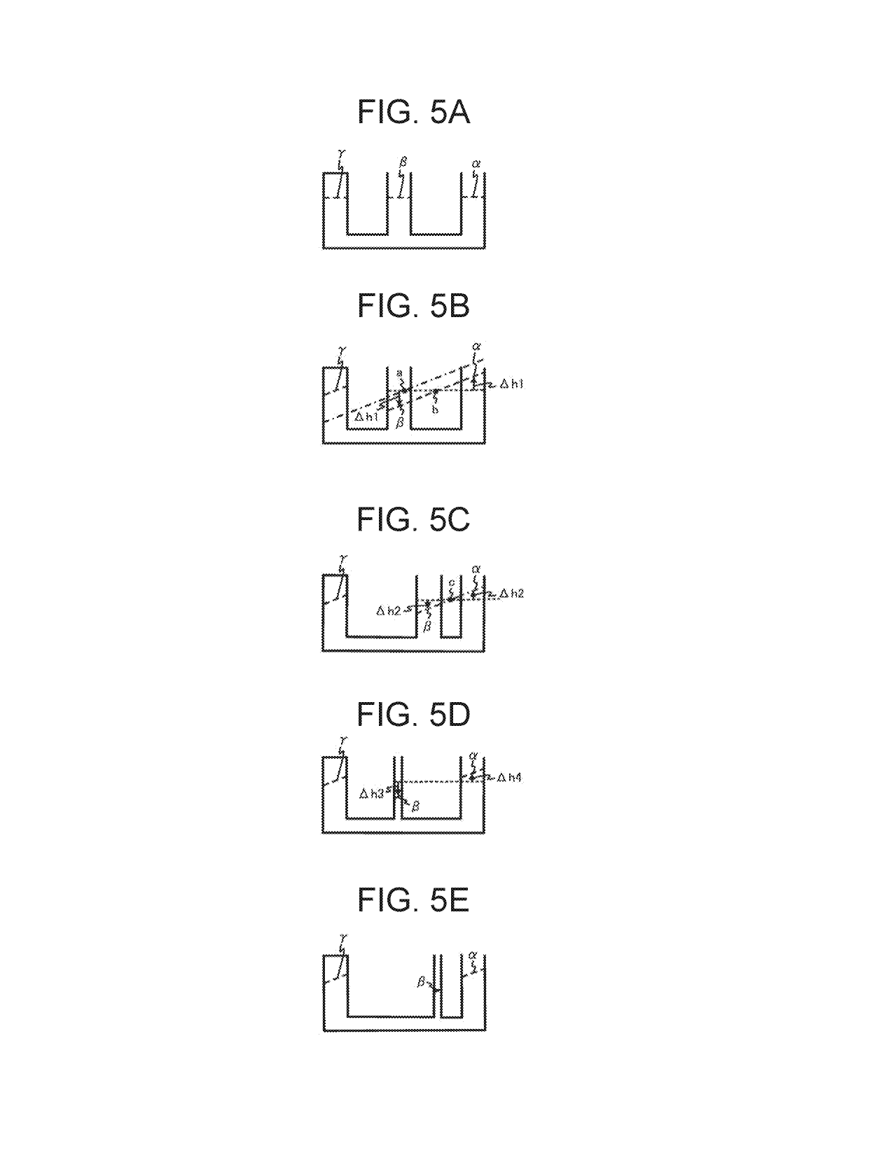

FIG. 5A is a view schematically illustrating an aspect of a water surface α of the product water in the first plate portion WB1, a water surface β of the product water in the second plate portion WB2, and a water surface γ of the product water in the space A, during non-acceleration and non-turning of the moving body M.

As illustrated in FIG. 5A, during non-acceleration and non-turning of the moving body M, the atmospheric pressure acts on each of the product water in the space A, the product water in the first plate portion WB1, and the product water in the second plate portion WB2, so that the water surface α, the water surface β, and the water surface γ become equal in height to each other.

FIG. 5B is a view schematically illustrating an aspect of the water surface α, the water surface β, and the water surface γ during acceleration or turning of the moving body M. It is assumed that when the product water in the space A tilts during the acceleration or the turning of the moving body M, the above-described air hole is closed to seal the space A.

As illustrated in FIG. 5B, during acceleration or turning of the moving body M, resultant force of a gravitational force and the inertia force acts on each of the product water in the first plate portion WB1 and the product water in the second plate portion WB2, in addition to the atmospheric pressure, so that the water surface α and the water surface β tilt in a direction perpendicular to a direction of the resultant force of the gravitational force and the inertia force. Accordingly, when the bottom of the water tank WT is taken as a reference point, the water surface β during the acceleration or the turning of the moving body M becomes lower than the water surface β during the non-acceleration and the non-turning of the moving body M by a specified amount Δh1, and when the bottom of the water tank WT is taken as a reference point, the water surface α during the acceleration or the turning of the moving body M becomes higher than the water surface α during the non-acceleration and the non-turning of the moving body M by the specified amount Δh1. Since the space A is sealed, the water surface γ is the same in height as the water surface γ during non-acceleration and non-turning of the moving body M.

When the water surface of the product water tilts, a position of a rotational axis of the water surface changes depending on a length in a direction perpendicular to a rotational direction along the water surface of the product water on which the atmospheric pressure acts. As the length in the direction perpendicular to the rotational direction along the water surface of the product water on which the atmospheric pressure acts decreases, the water surface of the product water becomes lower. For example, as illustrated in FIG. 5B, the rotational axis of the water surface of the product water in a case where the gas-liquid separator GLS does not include the first plate portion WB1 and the second plate portion WB2 is an axis a, and a length in the direction perpendicular to the rotational direction along the water surface of the product water coincides with the length of a long dashed short dashed line. On the other hand, a length in the direction perpendicular to the rotational direction along the water surface α and the water surface β of the product water coincides with the length of a broken line, and the length of the broken line is less than that of the long dashed short dashed line. Accordingly, the rotational axis of the inclination of the water surface α and the water surface β is an axis b located at a different position from the axis a, and the water surface α and the water surface β (from the bottom of water tank WT as the reference point and illustrated by the broken line) become lower than the water surface (from the bottom of water tank WT as the reference point and illustrated by the long dashed short dashed line) in the case where the gas-liquid separator GLS does not include the first plate portion WB1 and the second plate portion WB2.

As a result, in a case where the gas-liquid separator GLS includes the first plate portion WB1 and the second plate portion WB2, as compared with the case where the gas-liquid separator GLS does not include the first plate portion WB1 and the second plate portion WB2, it is suppressed that the product water flows back to the diluter DIL from the water tank WT during the acceleration or the turning of the moving body M.

In order to suppress that the product water flows back to the diluter DIL from the water tank WT, each length of the first plate portion WB1 and the second plate portion WB2 is desirable to be set, taking into account a maximum inclination angle of the water surface α and the water surface β during acceleration or turning of the moving body M.

FIG. 5C is a view schematically illustrating an aspect of the water surface α, the water surface β, and the water surface γ during acceleration or turning of the moving body M. It is assumed that when the product water in the space A tilts during the acceleration or the turning of the moving body M, the above-described air hole is closed to seal the space A. A distance between the first plate portion WB1 and the second plate portion WB2 illustrated in FIG. 5C is shorter than that between the first plate portion WB1 and the second plate portion WB2 illustrated in FIG. 5B.

As illustrated in FIG. 5C, when the bottom of the water tank WT is taken as the reference point, the water surface β during the acceleration or the turning of the moving body M becomes lower than the water surface β during the non-acceleration and the non-turning of the moving body M by a specified amount Δh2, and when the bottom of the water tank WT is taken as the reference point, the water surface α during the acceleration or the turning of the moving body M becomes higher than the water surface α during the non-acceleration and the non-turning of the moving body M by the specified amount Δh2. Since the space A is sealed, the water surface γ is the same in height as the water surface γ during the non-acceleration and the non-turning of the moving body M.

A length in the direction perpendicular to the rotational direction along the water surface α and the water surface β illustrated in FIG. 5C coincides with the length of a long dashed double-short dashed line, and the length of the long dashed double-short dashed line is less than the length of the long dashed short dashed line of FIG. 5B. Accordingly, the rotational axis of the inclination of the water surface α and the water surface β is an axis c located at a different position from the axis b, and the water surface α and the water surface β (from the bottom of the water tank WT as the reference point and illustrated by the long dashed double short dashed line) illustrated in FIG. 5C become lower than the water surface α and the water surface β (from the bottom of the water tank WT and illustrated by the broken line) illustrated in FIG. 5B, respectively. That is, the specified amount Δh2 is less than the specified amount Δh1.

Thus, as the distance between the first plate portion WB1 and the second plate portion WB2 shortens, the water surface α and the water surface β become further lower during acceleration or turning of the moving body M, so that it is further suppressed that the product water flows back to the diluter DIL from the water tank WT.

That is, the distance between the first plate portion WB1 and the second plate portion WB2 illustrated in FIG. 5C is set to a predetermined distance or less, and the predetermined distance is, for example, set to a minimum value of the distance between the first plate portion WB1 and the second plate portion WB2 in a case where the first communication port CH1 is formed in the first space S1 and the second communication port CH2 is formed in the second space S2.

FIG. 5D is a view schematically illustrating an aspect of the water surface α, the water surface β, and the water surface γ during acceleration or turning of the moving body M. It is assumed that when the product water in the space A tilts during the acceleration or the turning of the moving body M, the above-described air hole is closed to seal the space A. A distance between the first plate portion WB1 and the second plate portion WB2 illustrated in FIG. 5D is the same or substantially the same as that between the first plate portion WB1 and the second plate portion WB2 illustrated in FIG. 5B. The inner diameter of the first plate portion WB1 illustrated in FIG. 5D is the same as the inner diameter of the first plate portion WB1 illustrated in the FIG. 5B, and the area of the water surface α illustrated in FIG. 5D is the same as the area of the water surface α illustrated in FIG. 5B. The inner diameter of the second plate portion WB2 illustrated in FIG. 5D is smaller than that of the second plate portion WB2 illustrated in the FIG. 5B, and the area of the water surface β illustrated in FIG. 5D is smaller than that of the water surface β illustrated in FIG. 5B. The inner diameter of the second plate portion WB2 illustrated in FIG. 5D is smaller than that of the first plate portion WB1 illustrated in the FIG. 5D, and the area of the water surface β illustrated in FIG. 5D is smaller than that of the water surface α illustrated in FIG. 5D.

As illustrated in FIG. 5D, when the bottom of the water tank WT is taken as a reference point, the water surface β during the acceleration or the turning of the moving body M becomes lower than the water surface β during the non-acceleration and the non-turning of the moving body M by a specified amount Δh3, and when the bottom of the water tank WT is taken as a reference point, the water surface α during the acceleration or the turning of the moving body M becomes higher than the water surface α during the non-acceleration and the non-turning of the moving body M by a specified amount Δh4. Here, a variation in volume of the product water in the first plate portion WB1 and a variation in volume of the product water in the second plate portion WB2 are equal to each other because gravitational forces applied to the variations are balanced, so that a variation (specified amount Δh3) in level of the water surface β having a smaller area becomes larger than a variation (specified amount Δh4) in level of the water surface α having a larger area. The area of the water surface α illustrated in FIG. 5D is the same as the area of the water surface α illustrated in FIG. 5B, and the area of the water surface β illustrated in FIG. 5D is smaller than the area of the water surface β illustrated in FIG. 5B, so that the variation (specified amount Δh3) in level of the water surface β illustrated in FIG. 5D is larger than the variation (specified amount Δh1) in level of the water surface β illustrated in FIG. 5B, and the variation (specified amount Δh4) in level of the water surface α illustrated in FIG. 5D is smaller than the variation (specified amount Δh1) in level of the water surface α illustrated in FIG. 5B. Since the space A is sealed, the water surface γ is the same in height as the water surface γ during the non-acceleration and the non-turning of the moving body M.

Thus, the area of the water surface the level of which becomes lower during the acceleration or the turning of the moving body M is set to be smaller than the area of the water surface the level of which becomes higher during the acceleration or the turning of the moving body M, thereby increasing the variation in level of the water surface the level of which becomes lower and decreasing the variation in level of the water surface the level of which becomes higher. Thus, the level of the water surface α illustrated in FIG. 5D is made lower than the level of the water surface α illustrated in FIG. 5B, and the level of the water surface β illustrated in FIG. 5D is made lower than the level of the water surface β illustrated in FIG. 5B. As a result, it is further suppressed that the water surface of the product water in the water tank WT becomes higher during acceleration or turning of the moving body M.

Each inner diameter of the first plate portion WB1 and the second plate portion WB2 may be set so that the area of the water surface the level of which becomes higher during acceleration or turning of the moving body M is larger than the area of the water surface the level of which becomes lower during the acceleration or the turning of the moving body M. This configuration also increases the variation in level of the water surface the level of which becomes lower and decreases the variation in level of the water surface the level of which becomes higher. The configuration in which the inner diameter of the plate portion is increased makes it easier for the product water to flow back to the diluter DIL from the water tank WT. Accordingly, the configuration in which the inner diameter of the plate portion is decreased may be more effective in terms of suppressing the flowback of the product water.

Thus, during acceleration or turning of the moving body M, it is suppressed that the water surface of the product water in the water tank WT becomes higher, and hence, that the product water flows back to the diluter DIL from the water tank WT.

In a case where the first plate portion WB1 near the outlet OL illustrated in FIG. 2 is the plate portion in which the water level becomes higher during acceleration or turning of the moving body M, as illustrated in FIG. 5D, the inner diameter of the second plate portion WB2 may be set to be smaller than that of the first plate portion WB1, or the inner diameter of the first plate portion WB1 may be set to be larger than that of the second plate portion WB2. This further suppresses that the product water flows back from the water tank WT to the diluter DIL.

An inner diameter of each of the first plate portion WB1 and the second plate portion WB2 may be set so that the area of the water surface the level of which becomes higher during acceleration or turning of the moving body M increases and the area of the water surface the level of which becomes lower during the acceleration or the turning of the moving body M decreases. This configuration also increases the variation in level of the water surface the level of which becomes lower and decreases the variation in level of the water surface the level of which becomes higher.

FIG. 5E is a view schematically illustrating an aspect of the water surface α, the water surface β, and the water surface γ during acceleration or turning of the moving body M. It is assumed that when the product water in the space A tilts during the acceleration or the turning of the moving body M, the above-described air hole is closed to seal the space A.

A distance between the first plate portion WB1 and the second plate portion WB2 illustrated in FIG. 5E is shorter than that illustrated in FIG. 5B. The inner diameter of the second plate portion WB2 illustrated in FIG. 5E is smaller than that illustrated in FIG. 5B.

Thus, the water surface α and the water surface β become further lower during the acceleration or the turning of the moving body M by shortening the distance between the first plate portion WB1 and the second plate portion WB2 and by decreasing the inner dimeter of the second plate portion WB2. This further suppresses that the product water flows back to the diluter DIL from the water tank WT. The distance between the first plate portion WB1 and the second plate portion WB2 may be shortened, and the inner diameter of the first plate portion WB1 may be increased. Alternatively, the distance between the first plate portion WB1 and the second plate portion WB2 may be shortened, the inner diameter of the second plate portion WB2 may be decreased, and the inner diameter of the first plate portion WB1 may be increased.

That is, since the fuel cell module FCM of the embodiment includes the first plate portion WB1 and the second plate portion WB2, as compared with the fuel cell module that does not include the first plate portion WB1 and the second plate portion WB2, it is suppressed that the water surface of the product water in the water tank WT becomes higher during acceleration or turning of the moving body M. This suppresses that the product water flows back to the diluter DIL from the water tank WT during acceleration or turning of the moving body M, and hence, suppresses the increase of the product water in the diluter DIL. As a result, the product water in the diluter DIL is prevented from leaking to the outside of the diluter DIL through the outlet OL.

The water levels of the product water in the first plate portion WB1 and the second plate portion WB2 during acceleration or turning of the moving body M are made lower by shortening the distance between the first plate portion WB1 and the second plate portion WB2 or by changing the inner diameters of the first plate portion WB1 and the second plate portion WB2. This further suppresses that the product water flows back to the diluter DIL from the water tank WT, and hence, suppresses the increase of the product water in the diluter DIL. As a result, the product water in the diluter DIL is prevented from leaking to the outside of the diluter DIL through the outlet OL.

Note that the present disclosure is not limited to the above-described embodiment, and may be improved and modified in various ways within the gist of the present disclosure.

### First modification

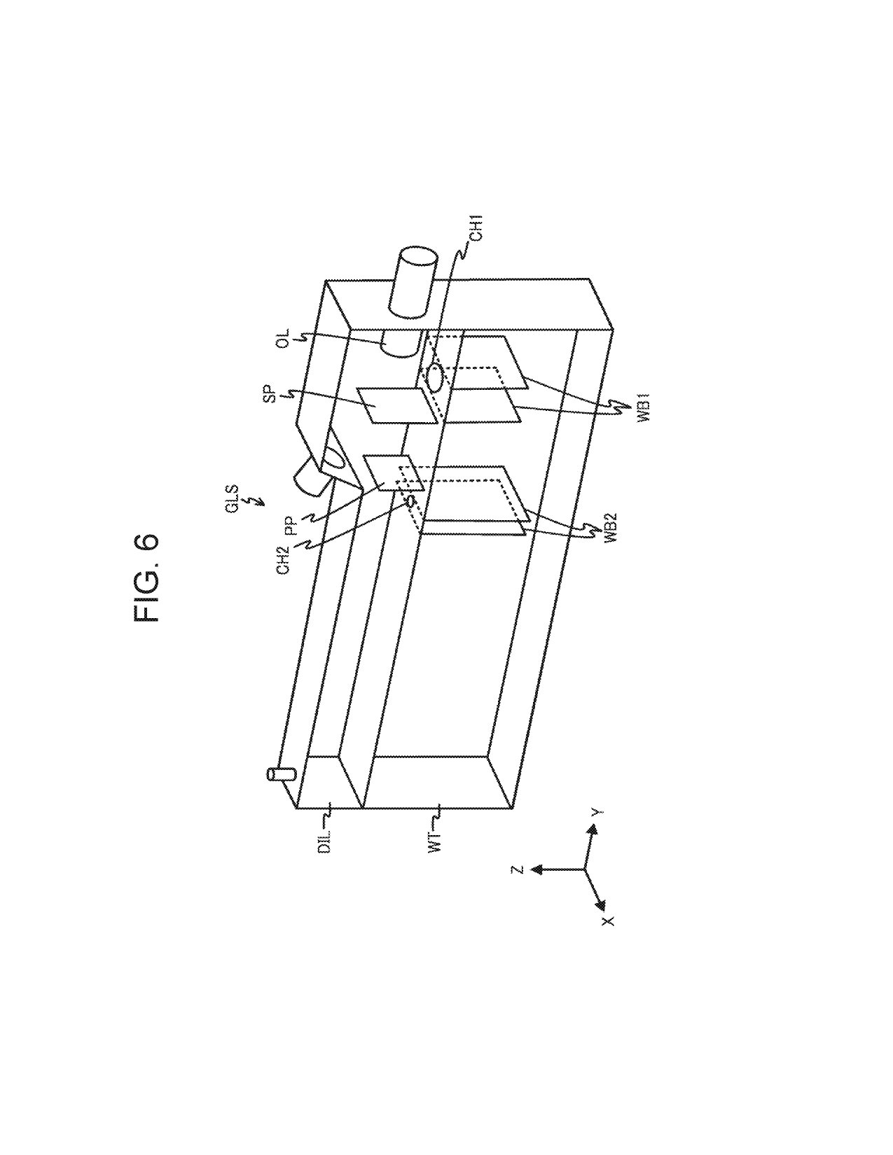

In the above-described embodiment, the first plate portion WB1 and the second plate portion WB2 are each formed in a substantially cylindrical shape; however, the shapes of the first plate portion WB1 and the second plate portion WB2 are not particularly limited as long as they are capable of adjusting the level of the water surface of the product water. For example, as illustrated in FIG. 6, the first plate portion WB1 and the second plate portion WB2 are each formed of two plate-like members. One end of the first plate portion WB1 located on the positive side in the X-axis direction, the other end of the first plate portion WB1 located on the negative side of in the X-axis direction, one end of the second plate portion WB2 located on the positive side of the X-axis direction, and the other end of the second plate portion WB2 located on the negative side in the X-axis direction are each connected to the wall of the water tank WT.

This configuration also suppresses that the product water flows back to the diluter DIL from the water tank WT during acceleration or turning of the moving body M, and hence, suppresses the increase of the product water in the diluter DIL. As a result, a water leakage prevention performance of the gas-liquid separator GLS may be improved.

### Second modification

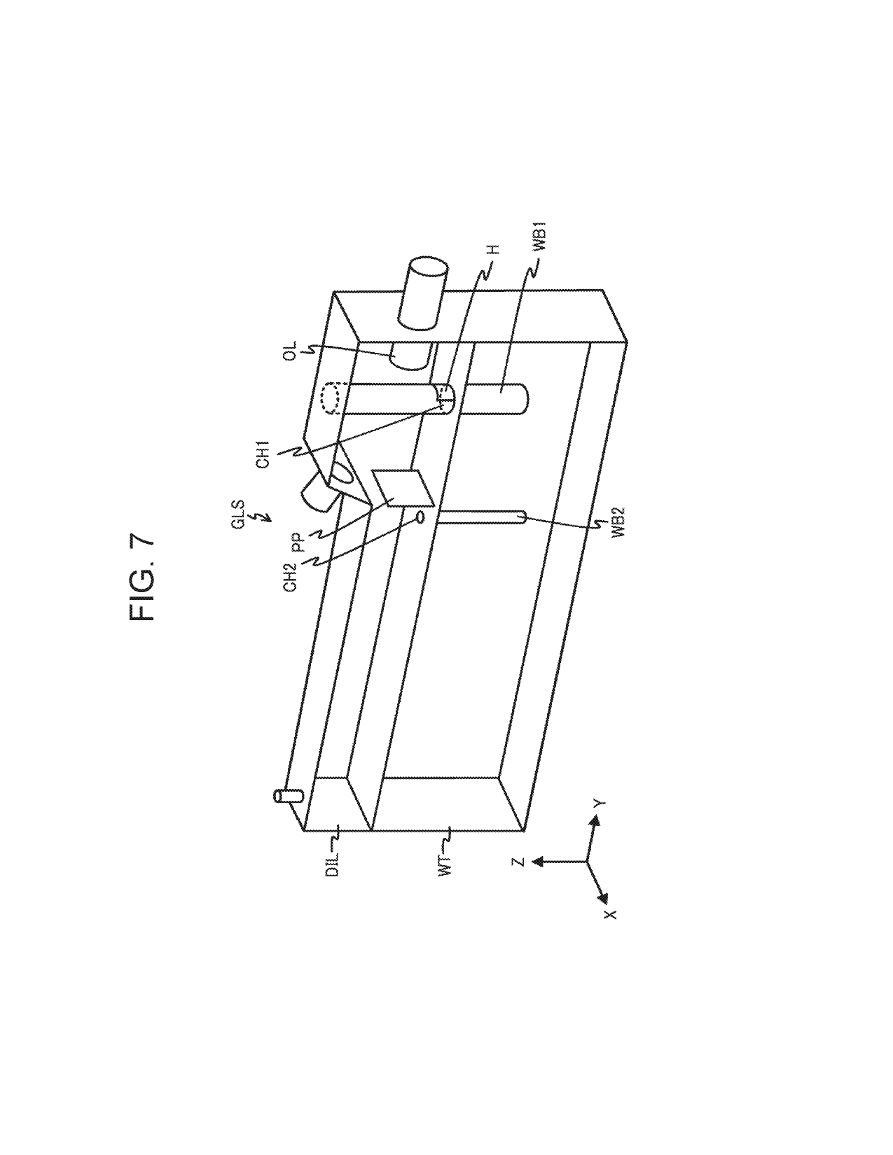

As illustrated in FIG. 7, the first plate portion WB1 may be formed so as to extend from the first communication port CH1 toward the bottom of the water tank WT and also extend from the first communication port CH1 toward the ceiling of the diluter DIL. In an example illustrated in FIG. 7, the end of the first plate portion WB1 located on the positive side in the Z-axis direction is connected to the ceiling of the diluter DIL; however, the end of the first plate portion WB1 located on the positive side in the Z-axis direction may be spaced apart from the ceiling of the diluter DIL. When the end of the first plate portion WB1 located on the positive side in the Z-axis direction is spaced apart from the ceiling of the diluter DIL, the end of the first plate portion WB1 located on the positive side in the Z-axis direction is preferably closed.

Here, the first plate portion WB1 has an opening H in a portion in contact with the bottom of the diluter DIL, of the extending portion of the first plate portion WB1 from the first communication port CH1 toward the ceiling of the diluter DIL. The product water in the first space S1 flows to the water tank WT through the opening H, the first communication port CH1, and the first plate portion WB1. In the example illustrated in FIG. 7, the opening H is formed so that the opening H faces the outlet OL and is not formed so that the opening H faces the partition plate PP. With this configuration, the flow of the oxidizing agent gas and the first product water, which is discharged from the fuel cell stack FCS and flows into the first space S1, is disturbed by the portion facing the partition plate PP, of the extending portion of the first plate portion WB1 from the first communication port CH1 toward the ceiling of the diluter DIL. Thus, the disturbance plate SP may be omitted as illustrated in FIG. 7, so that a manufacturing cost of the fuel cell module FCM may be reduced.

In the example illustrated in FIG. 7, the first plate portion WB1 is formed in a substantially cylindrical shape; however, the shape of the first plate portion WB1 is not particularly limited and may be formed in a substantially polygonal tubular shape. Furthermore, the first plate portion WB1 extending from the first communication port CH1 toward the ceiling of the diluter DIL may be formed of two plate-like members, as illustrated in FIG. 6. Thus, when the first plate portion WB1 is formed in a substantially polygonal tubular shape or formed of the two plate-like members, the flow of the oxidizing agent gas, which is discharged from the fuel cell stack FCS and flows into the first space S1, is efficiently disturbed, so that a dilution performance of the diluter DIL may be improved.

The opening H is preferably located at a position lower than the outlet OL. Thus, in a case where the opening H is located at the position lower than the outlet OL, even when the product water flows back to the diluter DIL from the water tank WT through the opening H, it is suppressed that the product water flows into the outlet OL. As a result, the product water is prevented from leaking to the outside of the diluter DIL.

What is claimed is:

1. A fuel cell module comprising:
a fuel cell; and
a gas-liquid separator including:
a diluter having:
a first space into which oxidizing agent gas and first product water that are discharged from the fuel cell flow;
a second space into which hydrogen gas and second product water that are discharged from the fuel cell flow; and
an outlet through which the hydrogen gas flowing into the second space is discharged, together with the oxidizing agent gas, to an outside of the diluter through the first space;
a water tank in which the first product water and the second product water are stored;
at least one first communication port through which the first product water and the second product water flow from the first space into the water tank;
at least one second communication port through which the first product water and the second product water flow from the second space into the water tank;
a first plate portion surrounding the first communication port and extending from the first communication port toward a bottom of the water tank; and
a second plate portion surrounding the second communication port and extending from the second communication port toward the bottom of the water tank.

2. The fuel cell module according to claim 1, wherein
the gas-liquid separator includes a partition plate that is provided between the first space and the second space and that causes the hydrogen gas to remain in the second space, and
the second communication port is located near the partition plate.

3. The fuel cell module according to claim 1, wherein
the gas-liquid separator includes a disturbance plate that is provided in the first space and that disturbs a flow of the oxidizing agent gas flowing into the first space, and
the first communication port is located near the disturbance plate interposed between the first communication port and a side from which the oxidizing agent gas flows into the first space.

4. The fuel cell module according to claim 1, wherein
a distance between the first plate portion and the second plate portion is equal to or less than a predetermined distance.

5. The fuel cell module according to claim 1, wherein
an inner diameter of the second plate portion is smaller than an inner diameter of the first plate portion.

6. The fuel cell module according to claim 1, wherein
the first plate portion extends from the first communication port toward a ceiling of the diluter, and has an opening facing the outlet.

7. The fuel cell module according to claim 6, wherein
the opening is located at a position lower than the outlet.
